(19) United States
(12) Patent Application Publication
(10) Pub. No.: US 2020/0071145 A1
(43) Pub. Date: Mar. 5, 2020

(54) ELEVATING DEVICE

(71) Applicant: Chih-Feng Chang, Tainan City (TW)

(72) Inventor: Chih-Feng Chang, Tainan City (TW)

(21) Appl. No.: 16/555,360

(22) Filed: Aug. 29, 2019

(30) Foreign Application Priority Data
Aug. 30, 2018 (TW) 107130398

(51) Int. Cl. B66F 9/08; B66F 9/07; B66F 9/075

(52) U.S. Cl. CPC B66F 9/08; B66F 2700/09; B66F 9/07504; B66F 9/072

(57) ABSTRACT

An elevating device includes an upper connecting seat, a lower connecting seat, at least one scissors unit, and a hoist. The lower connecting seat is vertically movable relative to the upper connecting seat between an upper position and a lower position. The at least one scissors unit interconnects the upper connecting seat and the lower connecting seat. The hoist is operable to release a rope to thereby move the lower connecting seat to the lower position and convert the at least one scissors unit to the expanded state, and is further operable to retract the rope to thereby move the lower connecting seat to the upper position and convert the at least one scissors unit to the contracted state.

### CROSS-REFERENCE TO RELATED APPLICATION

This application claims priority of Taiwanese Patent Application No. 107130398, filed on Aug. 30, 2018.

### FIELD

The disclosure relates to a transportation apparatus, and more particularly to an elevating device adapted for delivering objects such as material boxes.

### BACKGROUND

In traditional manufacturing, a product usually goes through multiple manufacturing processes before its completion, and these processes usually involve in-between procedures such as pick-and-place and transportation of materials. For example, during the process of making screws and nuts, intermediate or final products yielded from a molding machine are usually stored in a material box. The material box is then moved to a storage rack once a predetermined quantity of the products is met. Later, the material box is retrieved from the storage rack and transported to a predetermined location when the products needs to be further processed, tested, exported, etc.

In order to transport the material box, which has become heavily loaded, a transportation apparatus such as a forklift may be used, providing horizontal transportation for the material box. However, since the forklifts are relatively large in size, the forklifts are restricted from accessing certain places, such as a narrow passageway. Therefore, an overhead crane (or other machines of the like) may be used to transfer the material box to sites that are not forklift-accessible. Moreover, the overhead crane can provide vertical transportation to relatively high places. However, during such transportation, since the material box is lifted by a rope of the overhead crane, the material box is prone to swing movement, and deviate from a desired course, which may lead to unexpected outcome, including safety issues.

### SUMMARY

Therefore, the object of the disclosure is to provide an elevating device that can alleviate at least one of the drawbacks of the prior art.

According to the disclosure, the elevating device is adapted for use in a transportation apparatus. The transportation apparatus includes a delivering device that is horizontally movable, and a loading device that is disposed under the delivering device for loading and unloading an object. The elevating device includes an upper connecting seat, a lower connecting seat, at least one scissors unit, and a hoist. The upper connecting seat is adapted to be mounted to a bottom end of the delivering device. The lower connecting seat is adapted to be mounted onto a top end of the loading device, is disposed under the upper connecting seat, and is vertically movable relative to the upper connecting seat between an upper position and a lower position. The at least one scissors unit interconnects the upper connecting seat and the lower connecting seat, and includes a plurality of crisscross members that are vertically arranged and that are pivotally connected to each other. The at least one scissors unit is convertible during the vertical movement of the lower connecting seat between an expanded state, where the lower connecting seat is at the lower position, and a contracted state, where the lower connecting seat is at the upper position. The hoist includes a rope reel that is adapted to be mounted to the delivering device, and a rope that is connected between the rope reel and the lower connecting seat. The rope reel is operable to release the rope to thereby move the lower connecting seat to the lower position and convert the at least one scissors unit to the expanded state. The rope reel is further operable to retract the rope to thereby move the lower connecting seat to the upper position and convert the at least one scissors unit to the contracted state.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a transportation apparatus mounted with an embodiment of an elevating device according to the present disclosure;

FIG. 2 is a sectional side view of the transportation apparatus, illustrating a plurality of scissors units in a contracted state;

FIG. 3 is a sectional top view of the transportation apparatus, illustrating a lower connecting seat, a plurality of lower pivot arms and the scissors units of the embodiment and a loading device of the transportation apparatus;

FIG. 4 is a sectional bottom view of the transportation apparatus, illustrating an upper connecting seat, a plurality of upper pivot arms, a shock-absorbing bumper and a hoist of the embodiment and a delivering device and a loading device of the transportation apparatus; and

FIG. 5 is a fragmentary sectional side view of the transportation apparatus, illustrating the scissors units in an expanded state.

### DETAILED DESCRIPTION

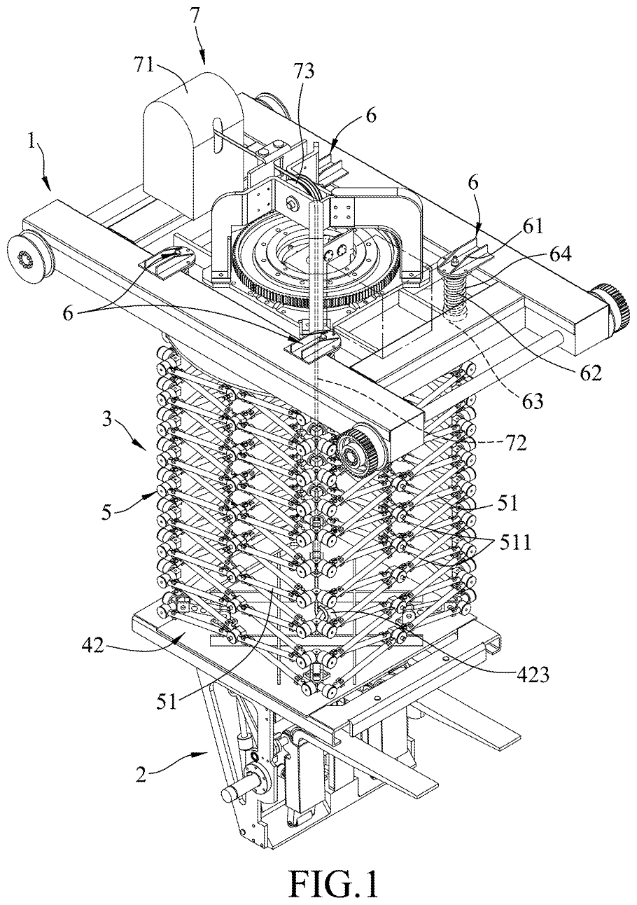

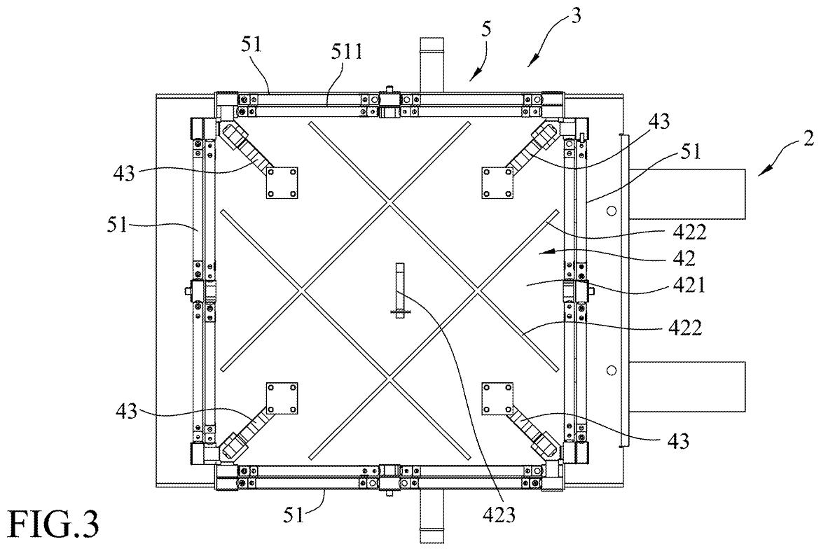

Referring to FIGS. 1 to 4, an embodiment of an elevating device 3 according to the disclosure is adapted for use in a transportation apparatus. The transportation apparatus includes a delivering device 1 that is horizontally movable, and a loading device 2 that is disposed under the delivering device 1 for loading and unloading an object such as a material box (not shown). The material box is used for storing items such as fasteners, tooling, or structural elements. Since the construction and functionality of the delivering device 1 and the loading device 2 are not within the focus of the present disclosure, they are not described further hereinafter.

In this embodiment, the elevating device 3 includes an upper connecting seat 41, a lower connecting seat 42, four upper pivot arms 43, four lower pivot arms 44, four scissors units 51, four shock-absorbing bumpers 6, and a hoist 7.

The upper connecting seat 41 is adapted to be mounted to a bottom end of the delivering device 1. The upper connecting seat 41 has an upper platform 411.

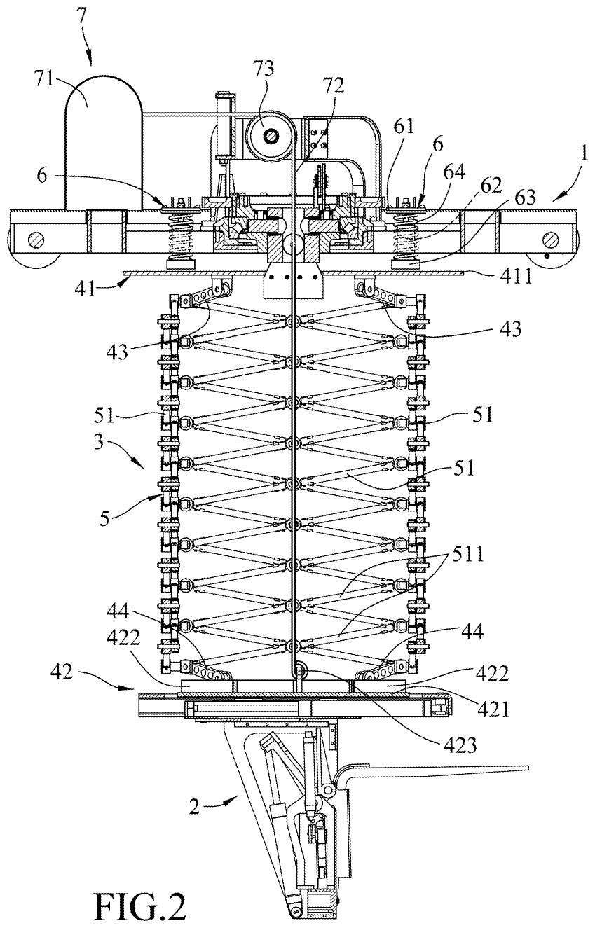

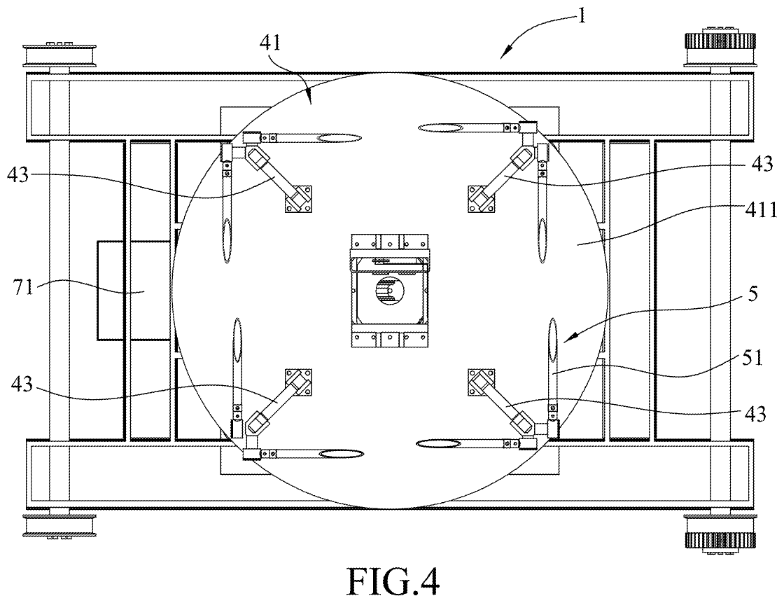

The lower connecting seat 42 is adapted to be mounted onto a top end of the loading device 2, is disposed under the upper connecting seat 41, and is vertically movable relative to the upper connecting seat 41 between an upper position (see FIG. 2) and a lower position (see FIG. 4). The lower connecting seat 42 has a lower platform 421, a plurality of lower strengthening ribs 422 formed on the lower platform 421 for strengthening the structure thereof, and a rope-connecting portion 423 disposed at a center of the lower platform 421.

Each of the upper pivot arms 43 is inclined and is pivotally connected to a bottom end of the upper platform 411 of the upper connecting seat 41. Each of the lower pivot arms 44 is disposed under a respective one of the upper pivot arms 43, is inclined, and is pivotally connected to a top end of the lower platform 421 of the lower connecting seat 42.

The four scissors units 51 form a rectangular framework 5 that interconnects the upper connecting seat 41 and the lower connecting seat 42. More specifically, each of the four upper pivot arms 43 pivotally interconnects the upper connecting seat 41 and a respective one of four top corners of the rectangular framework 5, and each of the four lower pivot arms 44 pivotally interconnects the lower connecting seat 42 and a respective one of four bottom corners of the rectangular framework 5. In such a manner, the four scissors units 51 synchronously extend or contract, so that the lower connecting seat 42 can move steadily downward or upward relative to the upper connecting seat 41 without jiggling. Furthermore, the scissors units 51 are convertible during the vertical movement of the lower connecting seat 42 between an expanded state, where the lower connecting seat 42 is at the lower position, and a contracted state, where the lower connecting seat (42) is at the upper position. However, it should be noted that the quantity of the scissors unit 51 is not limited to four. In other embodiments, the quantity of the scissors unit 51 may vary as needed.

In view of the structure of the scissors units 51, each of the scissors units 51 includes a plurality of crisscross members 511 that are vertically arranged and that are pivotally connected to each other, and each of the crisscross members 511 has two pivotally-connected rods to form a scissors mechanism. Moreover, each of the crisscross members 511 of the scissors units 51 has one end connected pivotally to a respective one of the crisscross members 511 of a horizontally-adjacent one of the scissors units 51, and an opposite end connected pivotally to a respective one of the crisscross members 511 of another horizontally-adjacent one of the scissors units 51.

The four shock-absorbing bumpers 6 are adapted to be mounted between and to interconnect the upper connecting seat 41 and the delivering device 1. Each of the shock-absorbing bumpers 6 includes a top member 61, a gas spring 62, a bottom member 63, and an elastic member 64. The top member 61 is adapted to be mounted to the delivering device 1, and the gas spring 62 has a top end that is connected to the top member 61. The bottom member 63 is disposed above and spaced apart from the upper connecting seat 41 and is connected to a bottom end of the gas spring 62. The elastic member 64 is sleeved on the gas spring 62 and is disposed between the top member 61 and the bottom member 63. In practice, the gas springs 62, being shock-absorbing, may be replaced by hydraulic pumps or hydraulic-gas pumps. In the present embodiment, the elastic members 64 are compression springs that are used for shock-absorbing and stabilizing the bottom member 63.

The hoist 7 includes a rope reel 71 that is adapted to be mounted to the delivering device 1, a rope 72 that is connected between the rope reel 71 and the rope-connecting portion 423 of the lower connecting seat 42, and a guiding wheel 73 that is adapted to be mounted to the delivering device 1, that is disposed above the rope-connecting portion 423, and that guides the rope 72 released from the rope reel 71 towards the connecting portion 423.

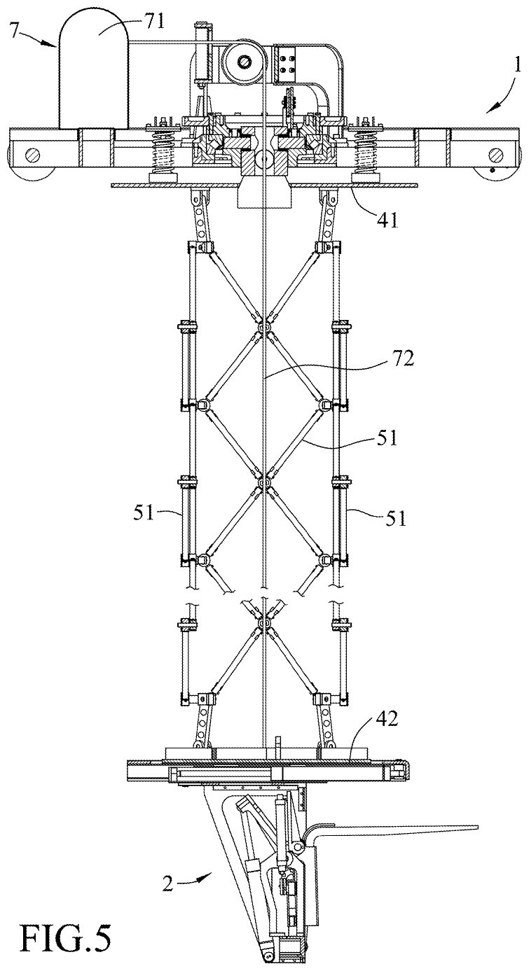

During use, the rope reel 71 is operable to release or retract the rope 72 to thereby move the lower connecting seat 42 to the lower position or the upper position, and to simultaneously convert the scissors units 51 to the expanded state or the contracted state. More specifically, to lower the lower connecting seat 42, a user may operate the rope reel 71 to release the rope 72, so that the lower connecting seat 42 is moved downwardly relative to the upper connecting seat 41 due to the weight of the loading device 2; meanwhile, the scissors units 51 are converted to the expanded state as shown in FIG. 5. In a similar manner, to raise the lower connecting seat 42, the user may operate the rope reel 71 to retract the rope 72, so that the lower connecting seat 42 is moved upwardly relative to the upper connecting seat 41 by a pulling force of the rope 72; meanwhile, the scissors units 51 are converted to the contracted state as shown in FIG. 2.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An elevating device adapted for use in a transportation apparatus, the transportation apparatus including a delivering device that is horizontally movable, and a loading device that is disposed under the delivering device for loading and unloading an object, said elevating device comprising:
an upper connecting seat adapted to be mounted to a bottom end of the delivering device;
a lower connecting seat adapted to be mounted onto a top end of the loading device, disposed under said upper connecting seat, and being vertically movable relative to said upper connecting seat between an upper position and a lower position;
at least one scissors unit interconnecting said upper connecting seat and said lower connecting seat, including a plurality of crisscross members that are vertically arranged and that are pivotally connected to each other, and being convertible during the vertical movement of said lower connecting seat between an expanded state, where said lower connecting seat is at the lower position, and a contracted state, where said. lower connecting seat is at the upper position; and
a hoist including a rope reel that is adapted to be mounted to the delivering device, and a rope that is connected between said rope reel and said lower connecting seat;
wherein said rope reel being operable to release said rope to thereby move said lower connecting seat to the lower position and convert said at least one scissors unit to the expanded state; and
wherein said rope reel being further operable to retract said rope to thereby move said lower connecting seat to the upper position and convert said at least one scissors unit to the contracted state.

2. The elevating device as claimed in claim 1, wherein each of said crisscross members has two pivotally-connected rods to form a scissors mechanism.

3. The elevating device as claimed in claim 2, wherein said at least one scissors unit includes four scissors units forming a rectangular framework.

4. The elevating device as claimed in claim 3, wherein each of said crisscross members of said scissors units has one end connected pivotally to a respective one of said crisscross members of a horizontally-adjacent one of said scissors units, and an opposite end connected pivotally to a respective one of said crisscross members of another horizontally-adjacent one of said scissors units.

5. The elevating device as claimed in claim 4, further comprising:
four upper pivot arms pivotally interconnecting said upper connecting seat and said scissors units; and
four lower pivot arms pivotally interconnecting said lower connecting seat and said scissors units.

6. The elevating device as claimed in claim. 5, wherein:
each of said four upper pivot arms is inclined and interconnects said upper connecting seat and a respective one of four top corners of said rectangular framework; and
each of said four lower pivot arms is inclined and interconnects said lower connecting seat and a respective one of four bottom corners of said rectangular framework.

7. The elevating device as claimed in claim 6, wherein:
said lower connecting seat includes a lower platform connected pivotally to said lower pivot arms, and a rope-connecting portion disposed at a center of said lower platform and connected to one end of said rope; and
said hoist further includes a. guiding wheel guiding said rope that is released from said rope reel towards said connecting portion.

8. The elevating device as claimed in claim 1, wherein said elevating device further comprises four shock-absorbing bumpers adapted to be mounted between said upper connecting seat and the delivering device.

9. The elevating device as claimed in claim 6, wherein said elevating device further comprises four shock-absorbing bumpers adapted to be mounted between said upper connecting seat and the delivering device.

10. The elevating device as claimed in claim 7, wherein said elevating device further comprises four shock-absorbing bumpers adapted to be mounted between said upper connecting seat and the delivering device.

11. The elevating device as claimed in claim 8, wherein each of said shock-absorbing bumpers includes a top member adapted to be mounted to the delivering device, a gas spring having a top end that is connected to said top member, a bottom member disposed above and spaced apart from said upper connecting seat and connected to a bottom end of said gas spring, and an elastic member sleeved on said gas spring and disposed between said top member and said bottom member.

12. The elevating device as claimed in claim 9, wherein each of said shock-absorbing bumpers includes a top member adapted to be mounted to the delivering device, a gas spring having a top end that is connected to said top member, a bottom member disposed above and spaced apart from said upper connecting seat and connected to a bottom end of said gas spring, and an elastic member sleeved on said gas spring and disposed between said top member and said bottom member.

13. The elevating device as claimed in claim 10, wherein each of said shock-absorbing bumpers includes a top member adapted to be mounted to the delivering device, a gas spring having a top end that is connected to said top member, a bottom member disposed above and spaced apart from said upper connecting seat and connected to a bottom end of said gas spring, and an elastic member sleeved on said gas spring and disposed between said top member and said bottom member.

14. The elevating device as claimed in claim 5, wherein:
said upper connecting seat has an upper platform connected pivotally to said upper pivot arms; and
said lower connecting seat has a lower platform connected pivotally to said lower pivot arms, and a plurality of lower strengthening ribs formed on said lower platform.
